(19) United States
(12) Patent Application Publication
(10) Pub. No.: US 2025/0364541 A1
(43) Pub. Date: Nov. 27, 2025

(54) NEGATIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Jin Seok PARK, Yongin-si (KR); Hyun NAM, Yongin-si (KR); Taeil LEE, Yongin-si (KR); JeongJoo PARK, Yongin-si (KR); Minho LEE, Yongin-si (KR); Yunshik CHO, Yongin-si (KR); Kyunghwa JUNG, Yongin-si (KR)

(73) Assignee: SAMSUNG SDI CO., LTD., Yongin-si (KR)

(21) Appl. No.: 19/010,511

(22) Filed: Jan. 6, 2025

(30) Foreign Application Priority Data
May 24, 2024 (KR) 10-2024-0067993

(51) Int. Cl. H01M 4/36; H01M 4/02; H01M 4/133; H01M 4/134; H01M 4/38; H01M 4/583; H01M 4/62; H01M 4/66; H01M 10/0525

(52) U.S. Cl. CPC H01M 4/366; H01M 4/133; H01M 4/134; H01M 4/386; H01M 4/583; H01M 4/622; H01M 4/661; H01M 10/0525; H01M 2004/021; H01M 2004/027

(57) ABSTRACT

Disclosed are negative electrodes and rechargeable lithium batteries including a negative electrode. The negative electrode includes a negative electrode current collector and a negative electrode active material layer on the negative electrode current collector. The negative electrode active material layer includes a first active material layer, a second active material layer, and a third active material layer that are stacked on the negative electrode current collector. At least one of the first, second, and third active material layer includes crystalline carbon. The second active material layer further includes a silicon-containing particle and a high-elasticity binder. The high-elasticity binder is an acrylic copolymer.

### CROSS-REFERENCE TO RELATED APPLICATION

This U.S. nonprovisional application claims priority under 35 U.S.C § 119 to Korean Patent Application No. 10-2024-0067993 filed on May 24, 2024 in the Korean Intellectual Property Office, the disclosure of which is hereby incorporated by reference in its entirety.

### BACKGROUND

The present disclosure relates to a negative electrode for a rechargeable lithium battery, and a rechargeable lithium battery including the negative electrode, and for example, to a multilayered negative electrode for a rechargeable lithium battery, and a rechargeable lithium battery including the multilayered negative electrode.

With increased spread of battery-using electronic devices, such as, e.g., mobile phones, laptop computers, electric vehicles, and the like, there is increasing demand for rechargeable batteries with high energy density and high capacity.

A rechargeable lithium battery typically includes a positive electrode, a negative electrode, and an electrolyte, the positive and negative electrodes including an active material in which intercalation and deintercalation are possible, and generates electrical energy caused by oxidation and reduction reactions when lithium ions are intercalated and deintercalated.

### SUMMARY

An example embodiment of the present disclosure provides a negative electrode having desired or improved lifetime characteristics for a rechargeable lithium battery.

An example embodiment of the present disclosure provides a rechargeable lithium battery having desired or improved lifetime characteristics.

According to an example embodiment of the present disclosure, a negative electrode for a rechargeable lithium battery may include a negative electrode current collector, and a negative electrode active material layer on the negative electrode current collector. The negative electrode active material layer may include a first active material layer, a second active material layer, and a third active material layer that are stacked, e.g., sequentially stacked, on the negative electrode current collector. Each, or at least one, of the first, second, and third active material layers may include crystalline carbon. The second active material layer may further include a silicon-containing particle and a high-elasticity binder. The high-elasticity binder may be or include an acrylic copolymer.

According to an example embodiment of the present disclosure, a negative electrode for a rechargeable lithium battery may include a negative electrode current collector, and a negative electrode active material layer on the negative electrode current collector. The negative electrode active material layer may include crystalline carbon, a silicon-containing particle, and a high-elasticity binder. The negative electrode active material layer may have a first region adjacent to the negative electrode current collector, a third region adjacent to a top surface of the negative electrode active material layer, and a second region on a center of the negative electrode active material layer. The second region may be vertically interposed between the first region and the third region. An amount of the silicon-containing particle in the second region may be greater than an amount of the silicon-containing particle in the first region. The amount of the silicon-containing particle in the second region may be greater than an amount of the silicon-containing particle in the third region. An amount of the high-elasticity binder in the second region may be greater than an amount of the high-elasticity binder in the first region. The amount of the high-elasticity binder in the second region may be greater than an amount of the high-elasticity binder in the third region.

According to an example embodiment of the present disclosure, a rechargeable lithium battery may include the negative electrode discussed above, a positive electrode that includes a positive electrode current collector and a positive electrode active material layer on the positive electrode current collector; and a separator between the negative electrode and the positive electrode.

### BRIEF DESCRIPTION OF DRAWINGS

FIG. 1 is a simplified conceptual diagram illustrating a rechargeable lithium battery according to an example embodiment of the present disclosure.

FIGS. 2 to 5 are simplified diagrams illustrating a rechargeable lithium battery according to an example embodiment of the present disclosure.

FIG. 6 is a cross-sectional view illustrating a rechargeable lithium battery according to an example embodiment of the present disclosure.

FIG. 7 is an enlarged view illustrating a negative electrode for a rechargeable lithium battery according to an example embodiment of the present disclosure.

FIG. 8 is a cross-sectional view illustrating a method of manufacturing a negative electrode according to an example embodiment of the present disclosure.

### DETAILED DESCRIPTION OF EMBODIMENTS

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this disclosure, it will be understood that, when an element is referred to as being “on” another element, the element can be directly on the other element or intervening elements may be present between therebetween. In the drawings, thicknesses of some components are exaggerated for effectively explaining the technical contents. Like reference numerals refer to like elements throughout the specification.

Unless otherwise specially noted in this disclosure, the expression of singular form may include the expression of plural form. In addition, unless otherwise specially noted, the phrase “A or B” may indicate “A but not B.” “B but not A.” and “A and B.” The terms “comprises/includes” and/or “comprising/including” used in this disclosure do not exclude the presence or addition of one or more other components.

As used herein, the term “combination thereof” may refer to a mixture, a stack, a composite, a copolymer, an alloy, a blend, or a reaction product.

Unless otherwise especially defined in this disclosure, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

In this disclosure, the term “substituted or unsubstituted” may refer to substituted or unsubstituted with at least one substituent including at least one of a deuterium atom, a halogen atom, a cyano group, a nitro group, an amine group, a silyl group, an oxy group, a thio group, a sulfinyl group, a sulfonyl group, a carbonyl group, a boron group, a phosphine oxide group, a phosphine sulfide group, an alkyl group, an alkenyl group, an alkoxy group, a hydrocarbon ring group, an aryl group, and a heterocyclic group. In addition, each substituent mentioned above may be substituted or unsubstituted. For example, a biphenyl group may be interpreted as an aryl group or as a phenyl group substituted with a phenyl group.

In this disclosure, the halogen atom may include one of fluorine, chlorine, bromine, and iodine atoms.

In this disclosure, an alkyl group may be linear or branched. The number of carbon atoms in the alkyl group may range from 1 to 50, from 1 to 30, from 1 to 10, or from 1 to 6. The alkyl group may include, for example, a methyl group, an ethyl group, an n-propyl group, an isopropyl group, an n-butyl group, an s-butyl group, a t-butyl group, an i-butyl group, a 2-ethylbutyl group, a 3,3-dimethylbutyl group, an n-pentyl group, an i-pentyl group, a neopentyl group, a t-pentyl group, a cyclopentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, a cyclohexyl group, a 4-methylcyclohexyl group, a 4-t-butylcyclohexyl group, an n-heptyl group, a 1-methylheptyl group, a 2,2-dimethylheptyl group, a 2-ethylheptyl group, a 2-butylheptyl group, an n-octyl group, t-octyl group, a 2-ethyloctyl group, a 2-butyloctyl group, a 2-hexyloctyl group, a 3,7-dimethyloctyl group, a cyclooctyl group, an n-nonyl group, an n-decyl group, an adamantyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-henicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, or an n-triacontyl group, but the present disclosure is not limited thereto.

In this disclosure, the alkenyl group may refer to a hydrocarbon group containing one or more carbon double bonds in the middle or at the end of an alkyl group with two or more carbon atoms. The alkenyl group may be linear or branched. The number of carbon atoms is not particularly limited, but may range from 2 to 30, from 2 to 20, or from 2 to 10. The alkenyl group may be or include, for example, a vinyl group, a 1-butenyl group, a 1-pentenyl group, a 1,3-butadienyl group, a styrenyl group, or a styrylvinyl group, but the present disclosure is not limited thereto.

In this disclosure, the alkynyl group may refer to a hydrocarbon group containing one or more carbon triple bonds in the middle or at the end of an alkyl group with two or more carbon atoms. The alkynyl group may be linear or branched. The number of carbon atoms is not particularly limited, but may range from 2 to 30, from 2 to 20, or from 2 to 10. The alkynyl group may be or include, for example, an ethynyl group or a propynyl group, but the present disclosure is not limited thereto.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

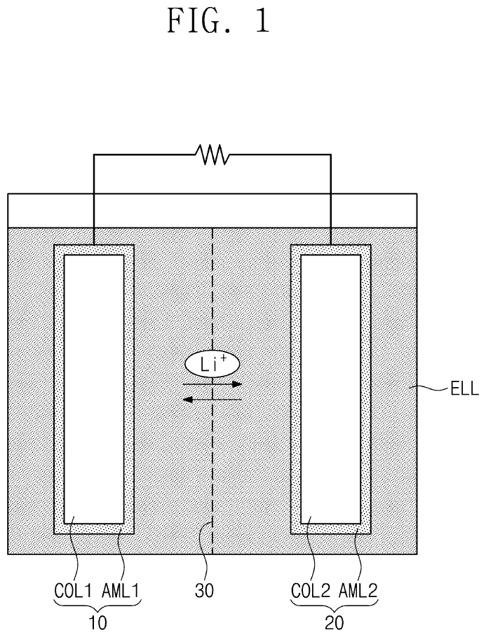

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be located between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material.

For example, the positive electrode 10 may further include an additive that can constitute a sacrificial positive electrode.

An amount of the positive electrode active material may be about 90 wt % to about 99.5 wt % relative to 100 wt % of the positive electrode active material layer AML1. An amount of each, or at least one, of the binder and the conductive material may be about 0.5 wt % to about 5 wt % relative to 100 wt % of the positive electrode active material layer AML1.

The binder may improve attachment of positive electrode active material particles to each other, and also improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause a chemical change in a battery may constitute the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may constitute the current collector COLI, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium, and a metal that is or includes at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90<a≤1.8, 0≤b≤<0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤<0.5, 0≤c≤0.5, and 0≤α≤2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may improve attachment of negative electrode active material particles to each other and also to improve attachment of the negative electrode active material to the current collector COL2. The binder may include a at least non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder constitutes the negative electrode binder, a cellulose-based compound capable of providing viscosity may further be included. A cellulose-based compound may constitute the thickener. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause a chemical change in a battery may constitute the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as at least one of non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is or includes at least one of from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) located on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material or the Sn-based negative electrode active material may be used in combination with a carbon-based negative electrode active material.

### Separator 30

Based on type of the rechargeable lithium battery, the separator 30 may be located between the positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, the coating layer including an organic material, an inorganic material, or a combination thereof.

The porous substrate may be or include a polymer layer including a polyolefin that is or includes at least one of polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth) acrylic copolymer.

The inorganic material may include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more solvents.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that is dissolved in the non-aqueous organic solvent to constitute a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N (lithium bis (fluorosulfonyl) imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

### Rechargeable Lithium Battery

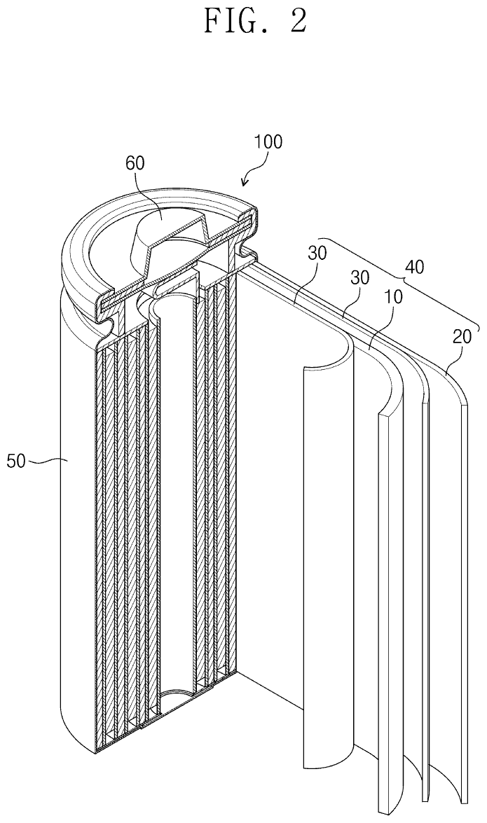

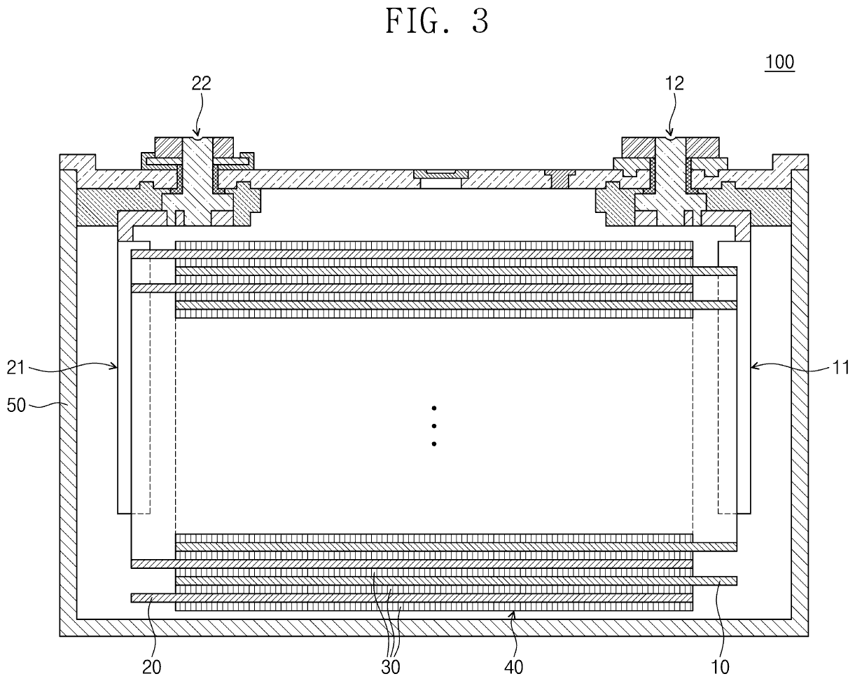

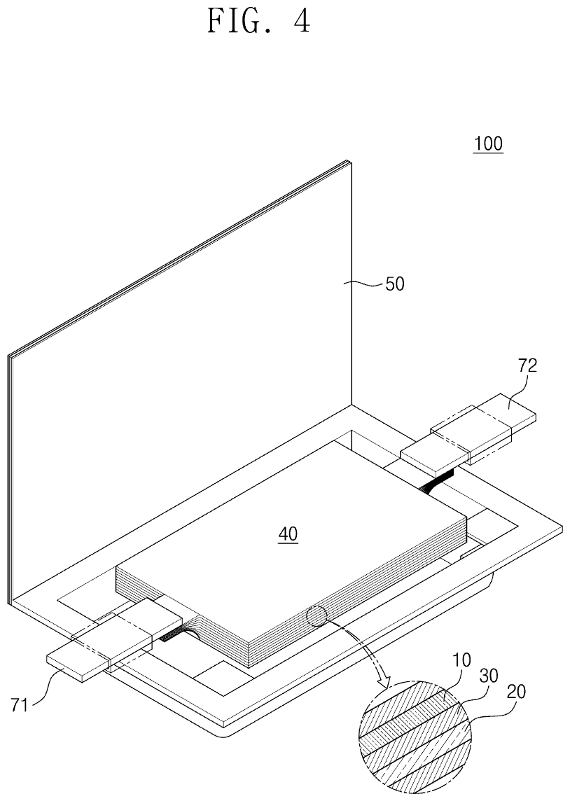

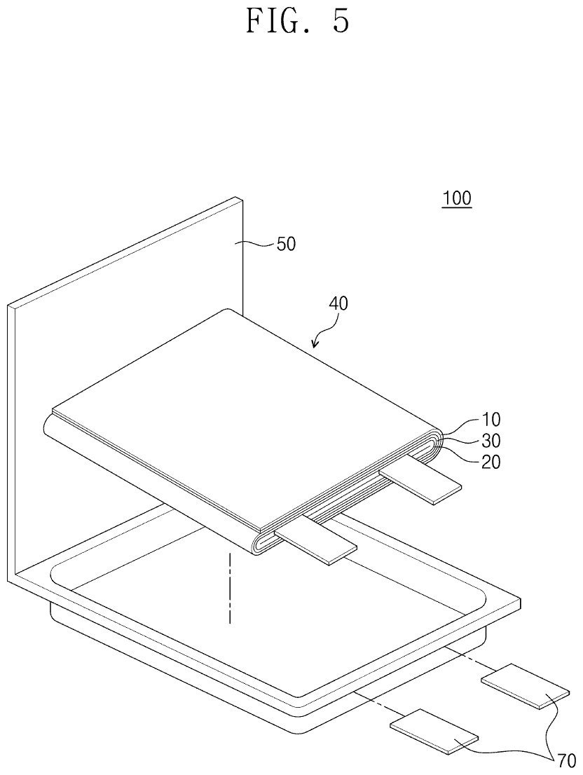

Based on the shape of a rechargeable lithium battery, the rechargeable lithium battery may be classified into cylindrical, prismatic, pouch, and coin types. FIGS. 2 to 5 illustrate simplified diagrams showing a rechargeable lithium battery according to an example embodiment, with FIG. 2 illustrating a cylindrical battery, FIG. 3 illustrating a prismatic battery, and FIGS. 4 and 5 illustrating pouch-type batteries. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50, as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tab 70/71/72 constituting an electrical path for externally inducing a current generated in the electrode assembly 40 to outside the battery 100.

The following description will focus on a rechargeable lithium battery according to some example embodiments of the present disclosure.

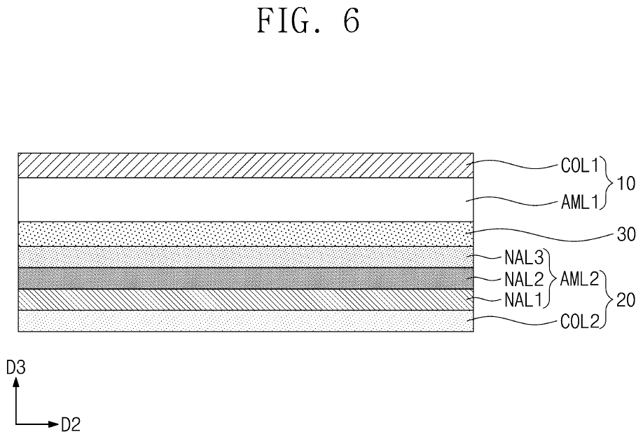

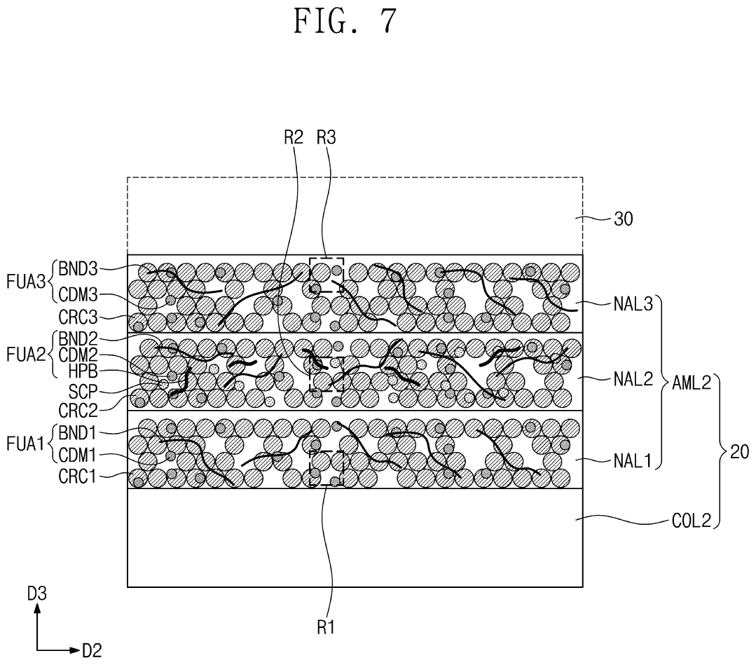

FIG. 6 illustrates a cross-sectional view showing a rechargeable lithium battery according to an example embodiment of the present disclosure. FIG. 7 illustrates an enlarged view showing a negative electrode for a rechargeable lithium battery according to an example embodiment of the present disclosure.

Referring to FIG. 6, as discussed above with reference to FIG. 1, a rechargeable lithium battery according to the present disclosure may include a positive electrode 10, a negative electrode 20, and a separator 30 between the positive electrode 10 and the negative electrode 20. Although not explicitly shown in FIG. 6, the rechargeable lithium battery according to the present disclosure may further include an electrolyte ELL. The separator 30 may be impregnated in the electrolyte ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may be interposed between the positive electrode active material layer AML1 and the negative electrode active material layer AML2.

Referring to FIG. 7 and as also illustrated in FIG. 6, the negative electrode active material layer AML2 according to an example embodiment of the present disclosure may have a multilayered structure. For example, the negative electrode active material layer AML2 may include a first active material layer NAL1, a second active material layer NAL2, and a third active material layer NAL3 that are stacked, e.g., sequentially stacked over one another. The first active material layer NAL1 may be directly located on the negative electrode current collector COL2. The second active material layer NAL2 may be interposed between the first active material layer NAL1 and the third active material layer NAL3.

The first to third active material layers NAL1 to NAL3 may include negative electrode active materials that are different from each other. The first to third active material layers NAL1 to NAL3 may have compositions that are different from each other. Each, or at least one, of the first to third active material layers NAL1 to NAL3 may include a carbon-based negative electrode active material, such as crystalline carbon, amorphous carbon, or any combination thereof. A detailed description thereof may be the same as the description of the negative electrode active material discussed above.

The first active material layer NAL1 may include a first crystalline carbon CRC1. The second active material layer NAL2 may include a second crystalline carbon CRC2 and a silicon-containing particle SCP. The third active material layer NAL3 may include a third crystalline carbon CRC3. Each, or at least one, of the first to third crystalline carbons CRC1 to CRC3 may be or include natural graphite, artificial graphite, or any mixture thereof.

In an example embodiment, each, or at least one, of the first active material layer NAL1 and the third active material layer NAL3 may further include a silicon-containing particle SCP, and an amount of the silicon-containing particle SCP included in each, or at least one, of the first and third active material layers NAL1 and NAL3 may be less than the amount of the silicon-containing particle SCP included in the second active material layer NAL2.

In an example embodiment of the present disclosure, a ratio of natural graphite among the first crystalline carbon CRC1 of the first active material layer NAL1 may be in a range of about 0 wt % to about 100 wt %, about 50 wt % to about 100 wt %, or about 80 wt % to about 100 wt %. In the first crystalline carbon CRC1 of the first active material layer NAL1, the ratio of natural graphite may be greater than the ratio of artificial graphite. In an example embodiment of the present disclosure, a ratio of artificial graphite among the third crystalline carbon CRC3 of the third active material layer NAL3 may be in a range of about 0 wt % to about 100 wt %, about 50 wt % to about 100 wt %, or about 80 wt % to about 100 wt %. In the third crystalline carbon CRC3 of the third active material layer NAL3, the ratio of artificial graphite may be greater than the ratio of natural graphite. For example, the first active material layer NAL1 may include natural graphite, the third active material layer NAL3 may include artificial graphite, and the second active material layer NAL2 may include a mixture of natural graphite and artificial graphite.

In an example embodiment of the present disclosure, the second active material layer NAL2 may further include an amorphous carbon and a silicon particle. The second active material layer NAL2 may include a silicon-carbon composite as the silicon-containing particle SCP which will be discussed below.

The second active material layer NAL2 may include carbon (C) and silicon (Si). The silicon (Si) may be originated from the silicon-containing particle SCP. The carbon (C) may be originated from at least one of crystalline carbon, amorphous carbon, and carbon in the silicon-containing particle SCP.

A ratio of Si in the second active material layer NAL2 may be in a range of about 5 wt % to about 99 wt %, about 5 wt % to about 30 wt %, or about 5 wt % to about 10 wt %. The silicon-containing particle SCP may include silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or any combination thereof), or any combination thereof.

As the second active material layer NAL2 includes the silicon-containing particle SCP, the second active material layer NAL2 may have an increased volume during charge of the rechargeable lithium battery. For example, a thickness of the second active material layer NAL2 may increase when the rechargeable lithium battery is charged. In contrast, the first active material layer NAL1 and the third active material layer NAL3 that are formed of or including only crystalline carbon may have no large variation in volume (or thickness). This may be caused by the fact that, when the rechargeable lithium battery is charged, the silicon-containing particle SCP intercalates lithium ions more than crystalline carbon. During charge and discharge of the rechargeable lithium battery, the first active material layer NAL1 and the third active material layer NAL3 may constitute a buffer layer to reduce a variation in volume (or thickness) of the second active material layer NAL2.

Each, or at least one, of the first to third active material layers NAL1 to NAL3 may further include a functional additive. For example, the first active material layer NAL1 may include a first functional additive FUA1. The second active material layer NAL2 may include a second functional additive FUA2. The third active material layer NAL3 may include a third functional additive FUA3. The first functional additive FUA1 may include a first binder BND1. The second functional additive FUA2 may include a high-elasticity binder HPB and a second binder BND2. The third functional additive FUA3 may include a third binder BND3.

During charge and discharge procedure, the silicon-containing particle SCP in the second active material layer NAL2 may repeatedly expand and shrink, and this may cause deterioration of the second active material layer NAL2. Accordingly, the rechargeable lithium battery may have reduced lifetime characteristics. As the second active material layer NAL2 includes the high-elasticity binder HPB, it may be possible to reduce or deterioration and to improve lifetime characteristics of the second active material layer NAL2. A kind of the high-elasticity binder HPB will be discussed below.

In an example embodiment, although not shown, the first functional additive FUA1 and the third functional additive FUA3 may also include a high-elasticity binder HPB. However, as the first active material layer NAL1 and the third active material layer NAL3 include either no silicon-containing particle SCP or a slight amount of the silicon-containing particle SCP, there may be a relatively small effect of reduction or suppression in volume change (shrinkage and expansion) of silicon-based active materials due to addition of the high-elasticity binder HPB. Therefore, an amount of the high-elasticity binder HPB included in each, or at least one, of the first and third functional additives FUA1 and FUA3 may be less than the amount of the high-elasticity binder HPB included in the second functional additive FUA2.

Each, or at least one, of the first to third binders BND1 to BND3 may include a non-aqueous binder, an aqueous binder, a dry binder, or a combination thereof. Each, or at least one, of the non-aqueous binder, the aqueous binder, and the dry binder may be or include at least one of the binders discussed in explaining the negative electrode 20 with reference to FIG. 1.

In an example embodiment, each, or at least one, of the first to third binders BND1 to BND3 may be or include an aqueous binder including at least one of styrene-butadiene rubber, (meth)acrylated styrene-butadiene rubber, (meth)acrylonitrile-butadiene rubber, (meth)acrylic rubber, butyl rubber, fluororubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, and a combination thereof. For example, each, or at least one, of the first to third binders BND1 to BND3 may be or include a rubber-based binder including at least one of styrene-butadiene rubber, (meth)acrylated styrene-butadiene rubber, (meth)acrylonitrile-butadiene rubber, (meth)acrylic rubber, butyl rubber, and fluororubber.

Each, or at least one, of the first to third binders BND1 to BND3 may further include a thickener capable of providing viscosity to slurry. For example, each, or at least one, of the first to third binders BND1 to BND3 may further include a cellulose-based compound discussed with reference to FIG. 1.

As the high-elasticity binder HPB is capable of providing viscosity to slurry, the high-elasticity binder HPB may replace the thickener. Thus, the second binder BND2 may include no cellulose-based compound. Alternatively, the second binder BND2 may include a cellulose-based compound, which amount is less than the amount of a cellulose-based compound included in each, or at least one, of the first and third binders BND1 and BND3.

The first functional additive FUAl may further include a first conductive material CDM1. The second functional additive FUA2 may further include a second conductive material CDM2. The third functional additive FUA3 may further include a third conductive material CDM3.

Each, or at least one, of the first to third conductive materials CDM1 to CDM3 may be one of the conductive materials of the negative electrode 20 discussed with reference to FIG. 1. For example, each, or at least one, of the first to third conductive materials CDM1 to CDM3 may include a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

In an example embodiment, in the negative electrode active material layer AML2, an amount of the first binder BND1 may be the same as the amount of the third binder BND3.

In an example embodiment, in the negative electrode active material layer AML2, an amount of the first binder BND1 may be greater than the amount of the third binder BND3. In an example embodiment, in the negative electrode active material layer AML2, an amount of the first binder BND1 may be less than the amount of the third binder BND3. A relatively large amount of binder may be distributed in the first active material layer NAL1 in contact with the negative electrode current collector COL2, and thus it may be possible to maintain an energy density and simultaneously to increase an adhesive force between a current collector and an active material layer.

In an example embodiment, the first functional additive FUA1 in the first active material layer NAL1 may be in an amount of about 1 wt % to about 10 wt %. For example, the first binder BND1 in the first active material layer NAL1 may be in an amount of about 0.2 wt % to about 5 wt %. The first binder BND1 may include a rubber-based binder and a thickener. The first conductive material CDM1 in the first active material layer NAL1 may be in an amount of about 0 wt % to about 5 wt %.

In an example embodiment, the second functional additive FUA2 in the second active material layer NAL2 may be in an amount of about 1.3 wt % to about 7 wt %. For example, the high-elasticity binder HPB in the second active material layer NAL2 may be in an amount of about 0.5 wt % to about 3 wt %. The second binder BND2 in the second active material layer NAL2 may be in an amount of about 1 wt % to about 2.2 wt %. The second binder BND2 may include a rubber-based binder. The second binder BND2 may further include a thickener. The rubber-based binder of the second binder BND2 may be in an amount of about 1 wt % to about 1.5 wt %. The thickener of the second binder BND2 may be in an amount of about 0 wt % to about 0.7 wt %.

The second conductive material CDM2 in the second active material layer NAL2 may be in an amount of about 0 wt % to about 5 wt %.

As the high-elasticity binder HPB in the second active material layer NAL2 is in an amount of about 0.5 wt % to about 3 wt %, a cell may increase in capacity and rapid charge rate.

In an example embodiment, the third functional additive FUA3 in the third active material layer NAL3 may be in an amount of about 2 wt % to about 10 wt %. For example, the third binder BND3 in the third active material layer NAL3 may be in an amount of about 0.5 wt % to about 5 wt %. The third binder BND3 may include a rubber-based binder and a thickener. The third conductive material CDM3 in the third active material layer NAL3 may be in an amount of about 0 wt % to about 5 wt %.

In an example embodiment, each, or at least one, of the first to third active material layers NAL1 to NAL3 may have a thickness of about 10 μm to about 50 μm.

In an example embodiment, the first to third active material layers NAL1 to NAL3 may have substantially the same thickness.

Alternatively, the second active material layer NAL2 may have a thickness greater than the thickness of the first active material layer NAL1. The thickness of the second active material layer NAL2 may be greater than the thickness of the third active material layer NAL3.

In an example embodiment, no distinct interfaces may be present between the first active material layer NAL1, the second active material layer NAL2, and the third active material layer NAL3. When the interfaces are not clearly distinguished, the interfaces may be determined through a concentration profile of silicon particles, or through a concentration profile of the high-elasticity binder HPB. For example, since amounts of the silicon particles and the high-elasticity binder HPB are abruptly increased in the second active material layer NAL2, the second active material layer NAL2 may be defined to refer to a section where concentrations of the silicon particles and the high-elasticity binder HPB are sharply increased and then rapidly decreased again, the third active material layer NAL3 may be defined to a layer above the second active material layer NAL2, and the first active material layer NAL1 may be defined to refer to a layer below the second active material layer NAL2.

For example, the determination of the interface through the concentration profile may be carried out in the following manner. A concentration of the silicon particles, or of the high-elasticity binder HPB, may be measured depending on a depth of the negative electrode active material layer AML2. There may be no particular limitation on a concentration measurement method, and for example, an optical method, an electron microscope analysis method, or an X-ray diffraction analysis method may be utilized. The concentration measurement method may measure a point where a concentration of the silicon particles or the high-elasticity binder HPB is abruptly increased, and then may measure a point where a concentration of the silicon particles or the high-elasticity binder HPB is rapidly decreased. Since amounts of the silicon particles and the high-elasticity binder HPB are abruptly increased in the second active material layer NAL2, the second active material layer NAL2 may be defined to refer to a region from the point where a concentration of the silicon particles or the high-elasticity binder HPB is abruptly increased to the point where a concentration of the silicon particles or the high-elasticity binder HPB is rapidly decreased. Afterwards, the first active material layer NAL1 may be defined to refer to a region (or a layer directed toward the negative electrode current collector COL2) of the negative electrode active material layer AML2 on a bottom surface of the second active material layer NAL2, and the third active material layer NAL3 may be defined to refer to a region (or a layer directed toward the separator 30) of the negative electrode active material layer AML2 on a top surface of the second active material layer NAL2.

For example, the “abrupt increase” in concentration may be a concentration increase of 50%, 100%, or 200% over a distance of 10 nm, and “rapid decrease” concentration may be a concentration decrease of 50%, 100%, or 200% over a distance of 10 nm.

Referring back to FIG. 7, a first region R1 may be defined to refer to a given sized space in the first active material layer NAL1. A second region R2 may be defined to refer to a given sized space in the second active material layer NAL2. A third region R3 may be defined to refer to a given sized space in the third active material layer NAL3. For example, the first region R1 may be or include a cubic space of about 100 nm×100 nm×100 nm in the first active material layer NAL1, the second region R2 may be or include a cubic space of about 100 nm×100 nm×100 nm in the second active material layer NAL2, and the third region R3 may be or include a cubic space of about 100 nm×100 nm×100 nm in the third active material layer NAL3. A concentration of the silicon particles or the high-elasticity binder HPB in the first to third regions R1 to R3 may be measured to determine a concentration of the silicon particles or the high-elasticity binder HPB in the first to third active material layers NAL1 to NAL3, respectively.

In an example embodiment, a composition of a partial region in the first to third active material layers NAL1 to NAL3 may be analyzed without determination of the interfaces to determine a concentration of the silicon particle or the high-elasticity binder HPB in the first to third active material layers NAL1 to NAL3, respectively. The first to third regions R1 to R3 may be defined in the following manner.

Referring again to FIG. 7, the first region R1 may be defined to refer to a cubic space (about 100 nm×100 nm×100 nm) centered around a point at a given distance in a third direction D3 from one surface of the negative electrode active material layer AML2 adjacent to the negative electrode current collector COL2. For example, the given distance may range from about 100 nm to about 200 nm.

The second region R2 may be defined to refer to a cubic space (about 100 nm×100 nm×100 nm) centered around a point at a given distance in the third direction D3, or in an opposite direction from the center (or the middle) of a thickness in the third direction D3, of the negative electrode active material layer AML2. For example, the given distance may be about 100 nm.

The third region R3 may be defined to refer to a cubic space (about 100 nm×100 nm×100 nm) centered around a point at a given distance in the third direction D3, or in an opposite direction from a top surface of the negative electrode active material layer AML2, or one surface of the negative electrode active material layer AML2 adjacent to the separator 30. For example, the given distance may range from about 100 nm to about 200 nm.

A concentration of the silicon particles or the high-elasticity binder HPB in the first to third regions R1 to R3 defined as discussed above may be measured to determine a concentration of the silicon particles or the high-elasticity binder HPB in the first to third active material layers NAL1 to NAL3, respectively.

The following description will focus on a high-elasticity binder.

### High-Elasticity Binder HPB

The high-elasticity binder HPB included in the second functional additive FUA2 may be or include an acrylic copolymer. For example, the high-elasticity binder HPB may include “a repeating unit derived from a first monomer” (hereinafter referred to as a first repeating unit), which in an acrylic acid-based monomer.

In an example embodiment, the first monomer may include at least one acrylic acid-based monomer that includes at least one of (meth)acrylic acid, metal salt of (meth)acrylic acid, ammonium salt of (meth)acrylic acid, and amine salt of (meth)acrylic acid.

In this disclosure, “(meth)” may or may not include a methyl group. For example, (meth)acrylate may refer to acrylate or methacrylate.

In the metal salt of (meth)acrylic acid, the metal may be or include alkali metal or alkaline earth metal. The metal may be or include, for example, lithium, sodium, potassium, calcium, or magnesium. For example, the metal salt of (meth)acrylic acid may include sodium acrylate, lithium acrylate, potassium acrylate, calcium acrylate, magnesium acrylate, sodium methacrylate, lithium methacrylate, potassium methacrylate, calcium methacrylate, or any combination thereof.

The ammonium salt of (meth)acrylic acid may be or include an ammonia neutralized product of (meth)acrylic acid.

The amine salt of (meth)acrylic acid may be or include an monoethanolamine neutralized product, a diethanolamine neutralized product, a hydroxylamine neutralized product, or any combination thereof.

The first repeating unit may include at least one of a carboxyl group (—COOH), a metal salt of carboxylic acid, an ammonium salt of carboxylic acid, an amine salt of carboxylic acid, or any combination thereof. For example, at least one of the metal salt of carboxylic acid, the ammonium salt of carboxylic acid, and the amine salt of carboxylic acid may be formed by performing a polymerization reaction of (meth)acrylic acid, and then substituting H+ of carboxyl group derived from (meth)acrylic acid unit with metal salt, ammonium salt, and amine salt. Alternatively, at least one of the metal salt of carboxylic acid, the ammonium salt of carboxylic acid, and the amine salt of carboxylic acid may be formed by polymerizing a mixture of (meth)acrylic acid, metal salt of (meth)acrylic acid, ammonium salt of (meth)acrylic acid, and amine salt of (meth)acrylic acid.

In an example embodiment, the first repeating unit may include a metal salt of carboxylic acid. As the first repeating unit includes the metal salt of carboxylic acid, it may be possible to reduce resistance in batteries. In addition, as the first repeating unit includes the metal salt of carboxylic acid, water solubility of the high-elasticity binder HPB may be increased to improve processability during electrode manufacturing.

In an example embodiment, among the first repeating unit included in the high-elasticity binder HPB, “a first repeating unit including metal salt of carboxylic acid” may have a ratio of about 20 mol % to about 100 mol %. This may mean that when, among the first repeating unit, “a first repeating unit including carboxyl group”, “a first repeating unit including metal salt of carboxylic acid”, “a first repeating unit including ammonium salt of carboxylic acid”, and “a first repeating unit including amine salt of carboxylic acid” have a total amount of 100 mol %, “a first repeating unit including a metal salt of carboxylic acid” may have a ratio of about 20 mol % to about 100 mol %.

In an example embodiment, a ratio of “a repeating unit including carboxyl group” among the first repeating unit may be ascertained by using various physical chemical analysis methods known in the art, for example, inductively coupled plasma (ICP) spectroscopy.

In an example embodiment, a ratio of “a first repeating unit including carboxyl group” may be determined by a mixture ratio of (meth)acrylic acid, metal salt of (meth)acrylic acid, ammonium salt of (meth)acrylic acid, and amine salt of (meth)acrylic acid that are used as the first monomer. For example, when (meth)acrylic acid and metal salt of (meth)acrylic mixed in a weight ratio of 80:20 are used as the first monomer, “a first repeating unit including metal salt of carboxylic acid” among the first repeating unit of the manufactured high-elasticity binder HPB may have a ratio of 20 mol %.

The high-elasticity binder HPB may further include “a repeating unit derived from a second monomer” (hereinafter referred to as a second repeating unit) and “a repeating unit derived from a third monomer” (hereinafter referred to as a third repeating unit).

In an example embodiment, the second monomer may be or include (meth)acrylonitrile, for example, acrylonitrile.

In an example embodiment, the third monomer may be or include (meth)acrylate including an ethylene glycol group or styrene including a sulfonate group. The styrene including a sulfonate group may be styrene in which benzene ring hydrogen is substituted with a sulfonate group.

In an example embodiment, the third monomer may have a weight average molecular weight (Mw) of less than about 3,000 g/mol, for example, about 200 g/mol to about 1,000 g/mol. When the weight average molecular weight (Mw) of the third monomer is less than about 3,000 g/mol, high reactivity may be achieved to increase a molecular weight of a synthesized binder. The increase in molecular weight of the synthesized binder may cause the slurry to have a viscosity at a given level or higher, thereby improving processability of slurry coating.

For example, the third monomer may be or include polyethylene glycol methacrylate or sodium styrene sulfonate.

When the third monomer is (meth)acrylate including an ethylene glycol group, an amount of each repeating unit may be as follows.

With respect to the total 100 wt % of the first repeating unit, the second repeating unit, and the third repeating unit in the high-elasticity binder HPB, a ratio of the first repeating unit may range from about 30 wt % to about 80 wt % or from about 35 wt % to about 75 wt %. With respect to the total 100 wt % of the first repeating unit, the second repeating unit, and the third repeating unit, a ratio of the second repeating unit may range from about 19 wt % to about 50 wt % or from about 22 wt % to about 45 wt %. With respect to the total 100 wt % of the first repeating unit, the second repeating unit, and the third repeating unit, a ratio of the third repeating unit may range from about 1 wt % to about 20 wt % or from about 3 wt % to about 15 wt %.

As the high-elasticity binder HPB includes the first repeating unit, the second repeating unit, and the third repeating unit that have their amount range above, it may be possible to improve all of water solubility, fabrication processability, and resistance reduction. For example, when an amount of the third repeating unit of the high-elasticity binder HPB falls within the range above, a battery may improve in lifetime and output characteristics.

In an example embodiment, when the third monomer is or includes styrene including a sulfonate group, an amount of each repeating unit may be as follows.

With respect to the total 100 wt % of the first repeating unit, the second repeating unit, and the third repeating unit in the high-elasticity binder HPB, a ratio of the first repeating unit may range from about 10 wt % to about 50 wt % or from about 15 wt % to about 45 wt %. The high-elasticity binder HPB may include the first repeating unit having a ratio that falls within any of the above ranges to improve water solubility, thereby enhancing dispersibility of a negative electrode active material, improving storage stability of compositions in a negative electrode active material layer, and effectively reducing or suppressing the occurrence of cracks during the negative electrode manufacturing process. With respect to the total 100 wt % of the first repeating unit, the second repeating unit, and the third repeating unit, a ratio of the second repeating unit may range from about 20 wt % to about 50 wt % or from about 25 wt % to about 45 wt %. The high-elasticity binder HPB may include the second repeating unit having a ratio that falls within the any of the above ranges to improve interfacial adhesion, to enhance dispersibility of a negative electrode active material, and to improve storage stability of compositions in a negative electrode active material layer. With respect to the total 100 wt % of the first repeating unit, the second repeating unit, and the third repeating unit, a ratio of the third repeating unit may range from about 10 wt % to about 50 wt % or from about 15 wt % to about 45 wt %. The high-elasticity binder HPB may include the third repeating unit having a ratio that falls within any of the above ranges to effectively reduce or suppress the occurrence of cracks during the negative electrode manufacturing process.

In an example embodiment, a weight average molecular weight (Mw) of the high-elasticity binder HPB may range from about 500,000 g/mol to about 1,500,000 g/mol, for example, from about 600,000 g/mol to about 1,000,000 g/mol. The weight average molecular weight may be measured as a polystyrene-equivalent value by gel filtration chromatography. Within any of the above ranges, a volume change of a silicon-based active material may be effectively reduced or suppressed.

The following will describe a preparation of the high-elasticity binder HPB.

The high-elasticity binder HPB may be prepared by polymerizing the first to third monomers. The polymerization may be performed by a typical method known to those skilled in the art, for example, emulsion polymerization, suspension polymerization, or solution polymerization. For example, a binder monomer mixture including the first to third monomers, an emulsifier, and an initiator may be mixed in a solvent, and heat or light may be applied to prepare the high-elasticity binder HPB.

In an example embodiment, the binder monomer mixture may include the first monomer. The binder monomer mixture may further include the second monomer and the third monomer.

Amounts of the first to third monomers in the binder monomer mixture may correspond to the respective ratios of the first to third repeating units in the high-elasticity binder HPB. For example, when the third monomer is (meth)acrylate including an ethylene glycol group, the first monomer in the binder monomer mixture may be in an amount of about 30 wt % to about 80 wt % or about 35 wt % to about 75 wt %. The second monomer in the binder monomer mixture may be in an amount of about 19 wt % to about 50 wt % or about 22 wt % to about 45 wt %. The third monomer in the binder monomer mixture may be in an amount of about 1 wt % to about 20 wt % or about 3 wt % to about 15 wt %. Alternatively, when the third monomer is styrene including a sulfonate group, the first monomer in the binder monomer mixture may be in an amount of about 10 wt % to about 50 wt % or about 15 wt % to about 45 wt %. The second monomer in the binder monomer mixture may be in an amount of about 20wt % to about 50 wt % or about 25 wt % to about 45 wt %. The third monomer in the binder monomer mixture may be in an amount of about 10 wt % to about 50 wt % or about 15 wt % to about 45 wt %.

The emulsifier may be or include at least one of long-chain fatty acid alkali salt, N-acrylamino acid salt, alkyl ether carboxylic acid salt, acylated peptide, alkyl sulfonate, alkylbenzene sulfonate, alkyl amino acid salt, alkyl naphthalene sulfonate, sulfosuccinate, sulfated oil, alkyl sulfate, alkyl ether sulfate, alkyl aryl ether sulfate, alkyl amide sulfate, alkyl phosphate, alkyl ether phosphate, alkyl aryl ether phosphate, and any combination thereof. The alkyl group may be or include a C1 to C20 alkyl group. The emulsifier may be or include, for example, sodium dodecylbenzene sulfonate.

The emulsifier may be added in an amount of about 0.1 parts by weight to about 3 parts by weight or about 0.1 parts by weight to about 2 parts by weight relative to the total 100 parts by weight of the binder monomer mixture. As the emulsifier is added within any of the above ranges, it may be possible to obtain a high-elasticity binder HPB having an appropriate size and adhesive force.

The initiator may be or include at least one of ammonium persulfate, potassium persulfate, hydrogen peroxide, t-butyl hydroperoxide, an azo compound initiator such as azobisisobutyronitrile, and any combination thereof.

The initiator may be included in an amount of about 0.1 parts by weight to about 3 parts by weight, or about 0.1 parts by weight to about 2 parts by weight, relative to the total 100 parts by weight of the binder monomer mixture.

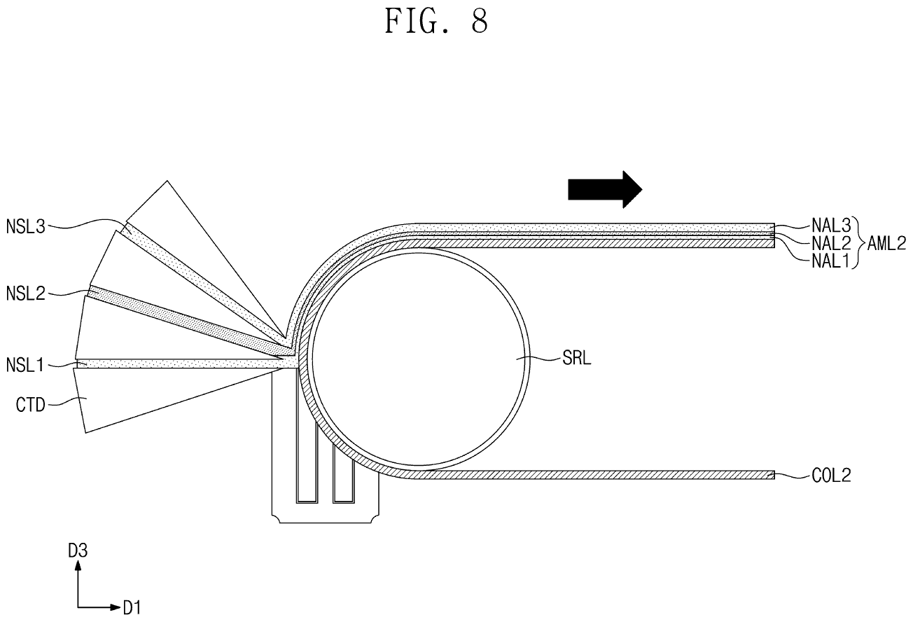

FIG. 8 illustrates a cross-sectional view showing a method of manufacturing a negative electrode according to an example embodiment of the present disclosure.

Referring to FIG. 8, a wound negative electrode current collector COL2 may be unwrapped and fed into a coating process. The traveling negative electrode current collector COL2 may be transported and coated in a first direction D1 by a supporting roll SRL. On the supporting roll SRL, the negative electrode current collector COL2 may undergo a coating process.

A coating die CTD may be disposed adjacent to the supporting roll SRL. The coating die CTD may include three holes for slurry injection. The three slurry injection holes may be respectively provided with a first negative electrode slurry NSL1, a second negative electrode slurry NSL2, and a third negative electrode slurry NSL3.

For example, the first negative electrode slurry NSL1 may include at least one of a first crystalline carbon CRC1, a first functional additive FUA1, and a solvent. The first functional additive FUAl may include a first binder and further include a first conductive material CDM1. The first binder BND1 may include a rubber-based binder and a thickener. The second negative electrode slurry NSL2 may include at least one of a second crystalline carbon CRC2, a silicon-containing particle SCP, a second functional additive FUA2, and a solvent. The second functional additive FUA2 may include at least one of a second binder BND2 and a high-elasticity binder HPB. The second functional additive FUA2 may further include a second conductive material CDM2. The third negative electrode slurry NSL3 may include at least one of a third crystalline carbon CRC3, a third functional additive FUA3, and a solvent. The third functional additive FUA3 may include a third binder BND3 and further include a third conductive material CDM3. The third binder BND3 may include a rubber-based binder and a thickener.

Each, or at least one, of the first to third crystalline carbons CRC1 to CRC3 may be or include natural graphite, artificial graphite, or any mixture thereof. For example, the first negative electrode slurry NSL1 may include natural graphite. The third negative electrode slurry NSL3 may include artificial graphite. Each, or at least one, of the first to third functional additives FUA1 to FUA3 may further include a conductive material.

The coating die CTD may be configured to cause the first negative electrode slurry NSL1, the second negative electrode slurry NSL2, and the third negative electrode slurry NSL3 to be coated, e.g., sequentially coated, on the negative electrode current collector COL2.

The solvent in the slurry may be or include a commonly used solvent in the art, and for example, the solvent in the slurry may include at least one of dimethyl sulfoxide (DMSO), isopropyl alcohol, N-methyl pyrrolidone (NMP), acetone, water, and any combination thereof.

The first negative electrode slurry NSL1, the second negative electrode slurry NSL2, and the third negative electrode slurry NSL3 coated on the negative electrode current collector COL2 may be dried to respectively form a first active material layer NAL1, a second active material layer NAL2, and a third active material layer NAL3 that are discussed above with reference to FIG. 6. A negative electrode active material layer AML2 may be constituted by the first active material layer NAL1, the second active material layer NAL2, and the third active material layer NAL3 that are stacked, e.g., sequentially stacked, on the negative electrode current collector COL2.

Afterwards, the negative electrode 20 may undergo a roll pressing process, a slitting process, and a notching process, e.g., may sequentially undergo the roll pressing process, the slitting process, and the notching process. The negative electrode 20, a separator 30, and a positive electrode 10 may be stacked, and an electrolyte ELL may subsequently be provided to fabricate a rechargeable lithium battery according to the present disclosure.

The following description will focus on some example embodiments of the present disclosure. The following example embodiments are provided to aid in understanding the present disclosure, and are not intended to limit the scope of the present disclosure.

### Preparation Example

### Preparation of Silicon-Carbon Composite

Crystalline carbon (e.g., graphite, GNs, soft carbon), nano-Si (D₅₀: 100 nm) ground fop 10 to 20 hours by using a Beads Mill (commercially available from NETZSCH), amorphous carbon (pitch, resin, hydrocarbon, and the like) were mixed in a weight ratio of 40:40:20, and then a homogenizer was used to uniformly disperse the mixture in a solvent (e.g., IPA, ETOH, and the like). The dispersed mixture was spray-dried at a temperature of 50° C. to 100° C. with a spray dryer, and thermally treated at a temperature of 900° C. to 1,000° C. in an N2furnace to coat amorphous carbon. Then, crushing and sieving with a 400 mesh were used to eventually obtain a silicon-carbon composite with an amorphous carbon coating layer.

### High-Elasticity Binder

### Preparation 1

Acrylic acid (AA) was used as the first monomer, acrylonitrile (AN) was used as the second monomer, and poly (ethylene glycol) methacrylate (weight average molecular weight (M_{w})=300 g/mol) was used as the third monomer. The first monomer, the second monomer, and the third monomer were mixed in a ratio of 45 wt %, 40 wt %, and 15 wt %, respectively, and then an initiator and water were added to a reactor to perform a copolymerization reaction, thereby preparing an aqueous solution of high-elasticity binder precursor.

Lithium hydroxide was added to the aqueous solution of high-elasticity binder precursor, and the mixture was stirred to prepare an aqueous solution of high-elasticity binder. In this stage, the lithium hydroxide was adjusted such that, among the first repeating unit derived from the first monomer, a ratio of a first repeating unit including lithium salt of carboxylic acid was 60 mol %. ICP spectroscopy was used to measure a ratio of lithium salt of carboxylic acid, and it was confirmed that, among the first repeating unit of the high-elasticity binder, a ratio of the first repeating unit including lithium salt of carboxylic acid was 60 mol %.

A viscosity at 25° C. of the prepared aqueous solution of high-elasticity binder was 2,670 cps based on a solid content of 6 wt %.

### Preparation 2

An aqueous solution of high-elasticity binder was prepared in the same method as in Preparation 1, with a difference that 15 wt % of sodium styrene sulfonate was used as the third monomer instead of 15 wt % of poly (ethylene glycol) methacrylate. A viscosity at 25° C. of the prepared aqueous solution of high-elasticity binder was 1,230 cps based on a solid content of 6 wt %.

### Example Embodiment 1

### Manufacture of Negative Electrode

98 wt % of natural graphite, 0.8 wt % of carboxymethyl cellulose, and 1.2 wt % of styrene-butadiene rubber were mixed in pure water to prepare a first negative electrode slurry.

44.4 wt % of natural graphite, 44.4 wt % of artificial graphite, 9 wt % of a silicon-carbon composite, 1 wt % of the high-elasticity binder obtained by Preparation 1, and 1.2 wt % of styrene-butadiene rubber were mixed in pure water to prepare a second negative electrode slurry.

98 wt % of artificial graphite, 0.8 wt % of carboxymethyl cellulose, and 1.2 wt % of styrene-butadiene rubber were mixed in pure water to prepare a third negative electrode slurry.

The first negative electrode slurry, the second negative electrode slurry, and the third negative electrode slurry were sequentially coated on a copper current collector. Thereafter, the obtained product was dried at 80° C. and then pressed to manufacture a negative electrode in which first to third active material layers were sequentially stacked on the copper current collector.

### Fabrication of Half Cell

The manufactured negative electrode was wound into a circular shape with a diameter of 12 mm, and then a 2032-type coin half-cell was fabricated with lithium metal as a counter electrode. An organic electrolyte was used in which 1.3M LiPF₆ was dissolved in a mixed solvent containing ethylene carbonate, diethyl carbonate, and fluoroethylene carbonate mixed in a weight ratio of 2:6:2.

### Fabrication of Full Cell

96 grams of LiNi_{0.6}Co_{0.2}Mn_{0.2}O₂ as a positive electrode active material, 2 grams of polyvinylidene fluoride, 47 grams of N-methyl pyrrolidone as a solvent, and 2 grams of carbon black as a conductive material were mixed to prepare a positive electrode slurry. A doctor blade was used to coat the positive electrode slurry on an aluminum current collector to manufacture a positive electrode. The positive electrode was dried at 135° C. for 3 hours or more, and then pressed and vacuum dried.

The manufactured negative electrode, a polytetrafluoroethylene (PTFE) separator, and the positive electrode were stacked to fabricate a rechargeable lithium battery. 1.3M LiPF₆, which dissolved in a mixed solvent containing ethylene carbonate (EC), ethylmethyl carbonate (EMC), and diethyl carbonate (DEC) mixed in a volume ratio of 3:5:2, was used as an electrolyte to fabricate a CR2032-type coin full-cell.

### Example Embodiment 2

A negative electrode, a half-cell, and a coin full-cell were fabricated in the same method as in Example Embodiment 1, with a difference that 44.4 wt % of natural graphite, 44.4 wt % of artificial graphite, 9 wt % of a silicon-carbon composite, 0.7 wt % of a high-elasticity binder obtained by Preparation 1, 0.3 wt % carboxymethyl cellulose, and 1.2 wt % of styrene-butadiene rubber were mixed in pure water to prepare a second negative electrode slurry.

### Example Embodiment 3

A negative electrode, a half-cell, and a coin full-cell were fabricated in the same method as in Example Embodiment 1, with a difference that 44.4 wt % of natural graphite, 44.4 wt % of artificial graphite, 9 wt % of a silicon-carbon composite, 0.5 wt % of a high-elasticity binder obtained by Preparation 1, 0.5 wt % carboxymethyl cellulose, and 1.2 wt % of styrene-butadiene rubber were mixed in pure water to prepare a second negative electrode slurry.

### Example Embodiment 4

A negative electrode, a half-cell, and a coin full-cell were fabricated in the same method as in Example Embodiment 1, with a difference that 43.9 wt % of natural graphite, 43.9 wt % of artificial graphite, 9 wt % of a silicon-carbon composite, 2 wt % of a high-elasticity binder obtained by Preparation 1, and 1.2 wt % of styrene-butadiene rubber were mixed in pure water to prepare a second negative electrode slurry.

### Example Embodiment 5

A negative electrode, a half-cell, and a coin full-cell were fabricated in the same method as in Example Embodiment 1, with a difference that 43.4 wt % of natural graphite, 43.4 wt % of artificial graphite, 9 wt % of a silicon-carbon composite, 3 wt % of a high-elasticity binder obtained by Preparation 1, and 1.2 wt % of styrene-butadiene rubber were mixed in pure water to prepare a second negative electrode slurry.

### Example Embodiment 6

A negative electrode, a half-cell, and a coin full-cell were fabricated in the same method as in Example Embodiment 1, with a difference that 44.5 wt % of natural graphite, 44.5 wt % of artificial graphite, 9 wt % of a silicon-carbon composite, 1 wt % of a high-elasticity binder obtained by Preparation 1, and 1 wt % of styrene-butadiene rubber were mixed in pure water to prepare a second negative electrode slurry.

### Example Embodiment 7

A negative electrode, a half-cell, and a coin full-cell were fabricated in the same method as in Example Embodiment 1, with a difference that 44.25 wt % of natural graphite, 44.25 wt % of artificial graphite, 9 wt % of a silicon-carbon composite, 1 wt % of a high-elasticity binder obtained by Preparation 1, and 1.5 wt % of styrene-butadiene rubber were mixed in pure water to prepare a second negative electrode slurry.

### Example Embodiment 8

A negative electrode, a half-cell, and a coin full-cell were fabricated in the same method as in Example Embodiment 1, with a difference that a high-elasticity binder of Preparation 2 was used instead of a high-elasticity binder of Preparation 1 when a second negative electrode slurry was prepared.

### Example Embodiment 9

A negative electrode, a half-cell, and a coin full-cell were fabricated in the same method as in Example Embodiment 2, with a difference that a high-elasticity binder of Preparation 2 was used instead of a high-elasticity binder of Preparation 1 when a second negative electrode slurry was prepared.

### Comparative Example 1

A negative electrode, a half-cell, and a coin full-cell were fabricated in the same method as in Example Embodiment 3, with a difference that carboxymethyl cellulose was used instead of a high-elasticity binder when a second negative electrode slurry was prepared.

For example, 44.4 wt % of natural graphite, 44.4 wt % of artificial graphite, 9 wt % of a silicon-carbon composite, 1 wt % of carboxymethyl cellulose, and 1.2 wt % of styrene-butadiene rubber were mixed in pure water to prepare a second negative electrode slurry.

### Comparative Example 2

A negative electrode, a half-cell, and a coin full-cell were fabricated in the same method as in Example Embodiment 1, with a difference that 44.4 wt % of natural graphite, 44.4 wt % of artificial graphite, 9 wt % of a silicon-carbon composite, 0.3 wt % of a high-elasticity binder obtained by Preparation 1, 0.7 wt % carboxymethyl cellulose, and 1.2 wt % of styrene-butadiene rubber were mixed in pure water to prepare a second negative electrode slurry.

### Comparative Example 3

A negative electrode, a half-cell, and a coin full-cell were fabricated in the same method as in Example Embodiment 1, with a difference that 43.15 wt % of natural graphite, 43.15 wt % of artificial graphite, 9 wt % of a silicon-carbon composite, 3.5 wt % of a high-elasticity binder obtained by Preparation 1, and 1.2 wt % of styrene-butadiene rubber were mixed in pure water to prepare a second negative electrode slurry.

### Comparative Example 4

A negative electrode, a half-cell, and a coin full-cell were fabricated in the same method as in Example Embodiment 1, with a difference that 44.75 wt % of natural graphite, 44.75 wt % of artificial graphite, 9 wt % of a silicon-carbon composite, 1 wt % of a high-elasticity binder obtained by Preparation 1, and 0.5 wt % of styrene-butadiene rubber were mixed in pure water to prepare a second negative electrode slurry.

### Comparative Example 5

A negative electrode, a half-cell, and a coin full-cell were fabricated in the same method as in Example Embodiment 1, with a difference that 44.0 wt % of natural graphite, 44.0 wt % of artificial graphite, 9 wt % of a silicon-carbon composite, 1 wt % of a high-elasticity binder obtained by Preparation 1, and 2.0 wt % of styrene-butadiene rubber were mixed in pure water to prepare a second negative electrode slurry.

### Comparative Example 6

A negative electrode, a half-cell, and a coin full-cell were fabricated in the same method as in Example Embodiment 1, with a difference that a high-elasticity binder was used instead of carboxymethyl cellulose when a first negative electrode slurry was prepared and that carboxymethyl cellulose was used instead of a high-elasticity binder when a second negative electrode slurry was prepared.

For example, 44.4 wt % of natural graphite, 44.4 wt % of artificial graphite, 9 wt % of a silicon-carbon composite, 1 wt % of the high-elasticity binder obtained by Preparation 1, and 1.2 wt % of styrene-butadiene rubber were mixed in pure water to prepare a first negative electrode slurry.

44.4 wt % of natural graphite, 44.4 wt % of artificial graphite, 9 wt % of a silicon-carbon composite, 1 wt % of carboxymethyl cellulose, and 1.2 wt % of styrene-butadiene rubber were mixed in pure water to prepare a second negative electrode slurry.

In this sense, a negative electrode, a half-cell, and a coin full-cell were fabricated such that a high-elasticity binder was included in the first active material layer but not in the second active material layer.

Table 1 shows amounts of materials used when a second electrode slurry was prepared in accordance with example embodiments and comparative examples. As discussed above, there were used a negative electrode active material (natural graphite, artificial graphite, and silicon-carbon composite), a high-elasticity binder (Example Embodiments 1 to 7 and Comparative Examples 1 to 4: a binder of Preparation 1. Example Embodiments 8 and 9: a binder of Preparation 2). a thickener (carboxymethyl cellulose), and rubber-based binder (styrene-butadiene rubber).

TABLE 1

| | Negative | High- | | Rubber- |
|---|---|---|---|---|
| | electrode | elasticity | | based |
| | active | binder | Thickener | binder |
| | material (wt %) | (wt %) | (wt %) | (wt %) |
| Example | 97.8 | 1 | — | 1.2 |
| Embodiment 1 | | | | |
| Example | 97.8 | 0.7 | 0.3 | 1.2 |
| Embodiment 2 | | | | |
| Example | 97.8 | 0.5 | 0.5 | 1.2 |
| Embodiment 3 | | | | |
| Example | 96.8 | 2 | — | 1.2 |
| Embodiment 4 | | | | |
| Example | 95.8 | 3 | — | 1.2 |
| Embodiment 5 | | | | |
| Example | 98 | 1 | — | 1 |
| Embodiment 6 | | | | |
| Example | 97.5 | 1 | — | 1.5 |
| Embodiment 7 | | | | |
| Example | 97.8 | 1 | — | 1.2 |
| Embodiment 8 | | | | |
| Example | 97.8 | 0.7 | 0.3 | 1.2 |
| Embodiment 9 | | | | |
| Comparative | 97.8 | — | 1 | 1.2 |
| Example 1 | | | | |
| Comparative | 97.8 | 0.3 | 0.7 | 1.2 |
| Example 2 | | | | |
| Comparative | 95.3 | 3.5 | — | 1.2 |
| Example 3 | | | | |
| Comparative | 98.5 | 1 | — | 0.5 |
| Example 4 | | | | |
| Comparative | 97.0 | 1 | — | 2.0 |
| Example 5 | | | | |
| *Comparative | 97.8 | — | 1 | 1.2 |
| Example 6 | | | | |

Negative electrode active material: natural graphite, artificial graphite, and silicon-carbon composite
Thickener: carboxymethyl cellulose
Rubber-based binder: styrene-butadiene rubber
*Comparative Example 6: 1 wt % of high-elasticity binder in the first active material layer

### Evaluation 1: Crack Generation

There was visually evaluated a crack generated during a process for coating the negative electrode slurry of Example Embodiments and Comparative Examples. For example, a surface of the negative electrode was visually observed to determine whether a crack is generated, and the result is listed in Table 2.

### Evaluation 2: Expansion Rate

The coin full-cells fabricated according to the Example Embodiments and the Preparations discussed above were charged at 0.5 C, 4.2 V, 0.05 C cut-off under the condition of constant current-constant voltage (CC-CV) and discharged at 0.5 C, 2.5 V cut-off under the condition of constant current (CC), and this charge/discharge cycle was performed 30 times. A battery thickness before charge/discharge and a battery thickness after charge/discharge were measured, and a negative electrode expansion rate was calculated according to Equation 1 below.

$$Expansion rate ( \% ) = \{ ( battery thickness after charge / discharge - battery thickness before charge / discharge ) / battery thickness before charge / discharge \} \times 100 \qquad [ Equation 1 ]$$

### Evaluation 3: Direct Current Internal Resistance (DC-IR)

The coin full-cells fabricated according to the Example Embodiments and the Preparations discussed above were charged and discharged one time at 25° C. under the conditions of 0.2 C charge and 0.2 C discharge, and a voltage drop (V) was measured while a current flow at 1 C for 1 second under SOC50 (charged to 50% of charge capacity relative to 100% of entire battery charge capacity, which is 50% discharged in a discharge state). A direct current internal resistance (DC-IR) was calculated from the result and is listed Table 2.

### Evaluation 4: Lifetime Characteristics

The coin full-cells fabricated according to the Example Embodiments and the Preparations were subjected to a charge/discharge experiment using an electrochemical analyzer (Toyo, Toscat-3100) at a temperature of 25° C. in a voltage range of 2.8 V to 4.25 V under a discharge rate of 0.2 C to 5.0 C, thereby measuring an initial charge capacity and an initial discharge capacity. Thereafter, the rechargeable lithium battery was subjected to 200 cycles of charge/discharge at a temperature of 25° C. in a driving voltage range of 2.8 V to 4.25 V under a condition of 1C/1C, and then a ratio of a discharge capacity at 200th cycle to an initial capacity (or a capacity retention) was measured and the measured value was defined as lifetime characteristics (%). The result is listed in Table 2.

TABLE 2

| | | | | Lifetime |
|---|---|---|---|---|
| | | | | characteristics |
| | | DC-IR | Expansion | at 200^{th} |
| Category | Crack | (mΩ) | rate (%) | cycle (%) |
| Example | X | 10.42 | 13 | 96.2 |
| Embodiment 1 | | | | |
| Example | X | 10.54 | 14.2 | 94.4 |
| Embodiment 2 | | | | |
| Example | X | 10.67 | 16 | 93.5 |
| Embodiment 3 | | | | |
| Example | X | 10.24 | 12.6 | 96.5 |
| Embodiment 4 | | | | |
| Example | X | 10.23 | 12.6 | 96.5 |
| Embodiment 5 | | | | |
| Example | X | 10.52 | 13.3 | 94.6 |
| Embodiment 6 | | | | |
| Example | X | 10.63 | 13.4 | 96 |
| Embodiment 7 | | | | |
| Example | X | 10.52 | 14.3 | 94.6 |
| Embodiment 8 | | | | |
| Example | X | 11.06 | 15.2 | 93.3 |
| Embodiment 9 | | | | |
| Comparative | X | 10.96 | 23.3 | 80.2 |
| Example 1 | | | | |
| Comparative | X | 10.69 | 20.4 | 83.5 |
| Example 2 | | | | |
| Comparative | ◯ | Cell could not | Cell could not | Cell could not |
| Example 3 | | be fabricated | be fabricated | be fabricated |
| Comparative | X | 10.56 | 16.2 | 78.4 |
| Example 4 | | | | |
| Comparative | X | 12.02 | 15.4 | 88.2 |
| Example 5 | | | | |
| Comparative | X | 10.84 | 20.5 | 82 |
| Example 6 | | | | |

Referring to Table 2, the cells of Comparative Examples 1, 2, and 6, in which the second active material layer includes substantially no high-elasticity binder or an extremely small amount of the high-elasticity binder, have high expansion rates and low lifetime characteristics (capacity retention rate). The negative electrode slurry of Comparative Example 3, which contains an excessive amount of the high-elasticity binder, has a viscosity that was too low for normal coating on a substrate, thereby making it challenging or impossible to fabricate the cell.

In addition, it may be observed that the cell of Comparative Example 5, which contains an excessive or large amount of rubber-based binder, exhibits a significantly increased direct-current resistance, and moderately reduced lifetime characteristics. However, it may be found that the cell of Comparative Example 4, which contains significantly small amount of rubber-based binder, exhibits remarkably reduced lifetime characteristics.

In contrast, the cells of Example Embodiments 1 to 7, which contain the high-elasticity binder of Preparation 1, and the cells of Example Embodiments 8 and 9, which contain the high-elasticity binder of Preparation 2, exhibit substantially no crack generation, have low internal resistances and expansion rates, and exhibit desired or improved lifetime characteristics.

In a negative electrode for a rechargeable lithium battery according to the present disclosure, a silicon-containing active material layer may be disposed between silicon-free active material layers to thereby mitigate a volume change of the silicon-containing active material layer. Further, a high-elasticity binder may be disposed in the silicon-containing active material layer to effectively reduce or suppress a change in volume of the silicon-based active material, and accordingly to reduce or suppress expansion caused by degradation of the rechargeable lithium battery. In conclusion, the rechargeable lithium battery according to the present disclosure may have improved lifetime characteristics.

What is claimed is:

1. A negative electrode for a rechargeable lithium battery, the negative electrode comprising:
a negative electrode current collector; and
a negative electrode active material layer on the negative electrode current collector,
wherein the negative electrode active material layer includes a first active material layer, a second active material layer, and a third active material layer that are stacked on the negative electrode current collector,
wherein at least one of the first, second, and third active material layers includes crystalline carbon,
wherein the second active material layer further includes a silicon-containing particle and a high-elasticity binder, and
wherein the high-elasticity binder includes an acrylic copolymer.

2. The negative electrode of claim 1, wherein the high-elasticity binder comprises:
a first repeating unit derived from a first monomer;
a second repeating unit derived from a second monomer; and
a third repeating unit derived from a third monomer,
wherein the first monomer includes at least one of (meth)acrylic acid, a metal salt of (meth)acrylic acid, an ammonium salt of (meth)acrylic acid, and an amine salt of (meth)acrylic acid.

3. The negative electrode of claim 2, wherein the first repeating unit includes metal salt of carboxylic acid in a ratio of about 20 mol % to about 100 mol % relative to a total amount of 100 mol % of the first repeating unit.

4. The negative electrode of claim 2, wherein the second monomer includes (meth)acrylonitrile.

5. The negative electrode of claim 2, wherein the third monomer includes at least one of (meth)acrylate including an ethylene glycol group, and styrene including a sulfonate group.

6. The negative electrode of claim 5, wherein a weight average molecular weight of the third monomer is equal to or less than about 3,000 g/mol.

7. The negative electrode of claim 1, wherein a weight average molecular weight of the high-elasticity binder is in a range of about 500,000 g/mol to about 1,500,000 g/mol.

8. The negative electrode of claim 1, wherein the high-elasticity binder is included in the second active material layer in an amount of about 0.5 wt % to about 3 wt %.

9. The negative electrode of claim 8, wherein the second active material layer further includes a rubber-based binder including at least one of styrene-butadiene rubber, (meth)acrylated styrene-butadiene rubber, (meth)acrylonitrile-butadiene rubber, (meth)acrylic rubber, butyl rubber, and fluororubber.

10. The negative electrode of claim 9, wherein the rubber-based binder is included in the second active material layer in an amount of about 1 wt % to about 1.5 wt %.

11. The negative electrode of claim 1, wherein at least one of the first, second, and third active material layers has a thickness of about 10 μm to about 50 μm.

12. The negative electrode of claim 1, wherein the silicon-containing particle includes at least one of silicon, a silicon-carbon composite, silicon oxide, and a Si-Q alloy, wherein Q includes at least one of an alkali metal, an alkaline earth metal, a Group 13 element, a Group 14 element except for Si, a Group 15 element, a Group 16 element, transition metal, and a rare-earth element.

13. A negative electrode for a rechargeable lithium battery, the negative electrode comprising:
a negative electrode current collector; and
a negative electrode active material layer on the negative electrode current collector,
wherein the negative electrode active material layer includes at least one of crystalline carbon, a silicon-containing particle, and a high-elasticity binder,
wherein the negative electrode active material layer has:
a first region adjacent to the negative electrode current collector;
a third region adjacent to a surface of the negative electrode active material layer opposite the negative electrode current collector; and
a second region on a center of the negative electrode active material layer,
wherein the second region is interposed between the first region and the third region,
wherein an amount of the silicon-containing particle in the second region is greater than an amount of the silicon-containing particle in the first region,
wherein the amount of the silicon-containing particle in the second region is greater than an amount of the silicon-containing particle in the third region,
wherein an amount of the high-elasticity binder in the second region is greater than an amount of the high-elasticity binder in the first region, and
wherein the amount of the high-elasticity binder in the second region is greater than an amount of the high-elasticity binder in the third region.

14. The negative electrode of claim 13, wherein:
the first region includes a first binder,
the third region includes a third binder, and
wherein at least one of the first binder and the third binder includes:
a rubber-based binder including at least one of styrene-butadiene rubber, (meth)acrylated styrene-butadiene rubber, (meth)acrylonitrile-butadiene rubber, (meth)acrylic rubber, butyl rubber, and fluororubber; and
a thickener.

15. The negative electrode of claim 14, wherein the thickener comprises a cellulose-based compound.

16. The negative electrode of claim 13, wherein the second region further comprises a second binder,
wherein the second binder comprises a rubber-based binder including at least one of styrene-butadiene rubber, (meth)acrylated styrene-butadiene rubber, (meth)acrylonitrile-butadiene rubber, (meth)acrylic rubber, butyl rubber, and fluororubber.

17. The negative electrode of claim 13, wherein the high-elasticity binder comprises:
a first repeating unit derived from a first monomer;
a second repeating unit derived from a second monomer; and
a third repeating unit derived from a third monomer,
wherein the first monomer includes at least one of (meth)acrylic acid, a metal salt of (meth)acrylic acid, an ammonium salt of (meth)acrylic acid, and an amine salt of (meth)acrylic acid.

18. The negative electrode of claim 13, wherein the high-elasticity binder is included in the second region in an amount of about 0.5 wt % to about 3 wt %.

19. The negative electrode of claim 13, wherein at least one of the first, second, and third active material layers has a thickness of about 10 μm to about 50 μm.

20. A rechargeable lithium battery, comprising:
the negative electrode as set forth in claim 1;
a positive electrode that includes a positive electrode current collector and a positive electrode active material layer on the positive electrode current collector; and
a separator between the negative electrode and the positive electrode.
